(19) United States
(12) Patent Application Publication
(10) Pub. No.: US 2021/0356124 A1
(43) Pub. Date: Nov. 18, 2021

(54) PROCESS BURNER AND PROCESS FOR COMBUSTION OF CARBON MONOXIDE-CONTAINING FUEL GASES

(71) Applicant: L'Air Liquide, Société Anonyme pour l'Etude et l'Exploitation des Procédés Georges Claude, Paris (FR)

(72) Inventors: Antonio COSCIA, Hadamar (DE); Katja BARTELS, Frankfurt (DE)

(21) Appl. No.: 17/320,729

(22) Filed: May 14, 2021

(30) Foreign Application Priority Data
May 15, 2020 (EP) 20020224.0

(51) Int. Cl. F23D 14/22; F23D 14/66; C10G 9/36; F23D 14/32

(52) U.S. Cl. CPC F23D 14/22; F23D 14/66; F23D 14/32; C10G 9/36; F23D 2212/10; F23D 2203/005

(57) ABSTRACT

The invention relates to a process burner for combustion of a plurality of fuel gases with a gaseous auxiliary medium, wherein one of the fuel gases comprises carbon monoxide (CO). The process burner according to the invention includes a first fuel gas unit, a second fuel gas unit and an auxiliary media unit. A first fuel gas which may be natural gas for example is introduced into the process burner via a first fuel gas nozzle in the region of the combustion zone. Carbon monoxide-containing fuel gas is introduced into the process burner via the second fuel gas unit, wherein a second fuel gas nozzle for introducing the carbon monoxide-containing fuel gas is arranged in the region of the auxiliary media unit.

### CROSS REFERENCE TO RELATED APPLICATIONS

This application is a 371 of PCT/EP2019/025367, filed Oct. 28, 2019, which claims priority to EP 18020568.4, filed Nov. 1, 2018, the entire contents of which are incorporated herein by reference.

### BACKGROUND

### Technical Field of the Invention

The invention relates to a process burner for combustion of a plurality of fuel gases with a gaseous auxiliary medium, wherein one of the fuel gases comprises carbon monoxide (CO). The invention further relates to a steam reformer or steam cracker comprising a process burner according to the invention. The invention further relates to a process for combustion of a plurality of fuel gases with a gaseous auxiliary medium in a process burner, wherein the process burner comprises a first fuel gas unit, a second fuel gas unit and an auxiliary media unit and wherein one of the fuel gases comprises carbon monoxide (CO), The invention further relates to the use of the process burner according to the invention in a process according to the invention.

### Prior Art

Process burners are employed in heating apparatuses and furnaces in the petrochemical and chemical process industries. For example process burners are employed as heating apparatuses in steam reformers for heating the reaction tubes arranged vertically in a furnace. Performed in the reaction tubes is a reaction of natural gas or other suitable carbon-containing inputs with steam over nickel catalysts to form synthesis gas as the primary product. Synthesis gas is a mixture of hydrogen, carbon monoxide and undesired by-products such as carbon dioxide.

If the production of synthesis gas serves mainly for production of hydrogen the carbon monoxide is either further converted to hydrogen and carbon dioxide by the known water gas shift reaction or is removed from the primary synthesis gas mixture. This may be effected for example using a pressure swing adsorption apparatus. In such processes there is often a requirement to recycle a portion of the carbon monoxide to the process burner as fuel. A multiplicity of further circumstances under which carbon monoxide is to be used as fuel for a process burner are conceivable.

In the combustion of carbon monoxide with oxygen to afford carbon dioxide the actual combustion reaction is in competition with the exothermic Boudouard reaction, also known as the Boudouard equilibrium, according to

2CO [symbol] C(solid)+CO₂,

wherein formation of solid carbon and carbon dioxide is favoured by high pressures and low temperatures according to the Le Chatelier principle. Nevertheless even at the prevailing high temperatures in the combustion zone in the region of the burner tile, also known as the burner block, process burners suffer from the problem of coking of fuel gas conduits, burner lances or burner nozzles due to solid carbon deposits. This is the case independently of whether the carbon monoxide is introduced into the burner system in a mixture with other fuel gases or separately. The aforementioned deposits result in blockages in said components which increases maintenance costs and causes combustion to become inefficient.

A burner for injection of a mixed fuel composed of at least hydrogen and carbon monoxide into the combustion chamber of a gas turbine is described for example in EP 1736707 A2.

Due to the problems of carbon deposits in certain burner components there is therefore a need for improving known burners using carbon monoxide as fuel and for improving corresponding known processes for combustion of carbon monoxide-containing fuel gases.

### SUMMARY

It is an object of the present invention to at least partially overcome the aforementioned disadvantages of the prior art.

It is in particular an object of the present invention to provide a burner for combustion of carbon monoxide-containing fuel gases which is configured such that compared to conventional burners deposits of solid carbon in certain burner components, in particular the fuel gas conduits, burner lances and burner nozzles, are at least reduced or completely prevented.

It is a further object of the present invention to provide a process for combustion of carbon monoxide-containing fuel gases which is configured such that compared to known processes less carbon, if any, is formed.

The independent claims provide a contribution to the at least partial achievement of at least one of the above objects. The dependent claims provide preferred embodiments which contribute to the at least partial achievement of at least one of the objects. Preferred embodiments of constituents of one category according to the invention are, where relevant, likewise preferred for identically named or corresponding constituents of a respective other category according to the invention.

The terms “having”, “comprising” or “containing”, etc., do not preclude the possible presence of further elements, ingredients, etc. The indefinite article “a” does not preclude the possible presence of a plurality.

The objects of the present invention are at least partially achieved by a process burner for combustion of a multiplicity of fuel gases with a gaseous auxiliary medium, wherein one of the fuel gases comprises carbon monoxide (CO), comprising

a. a first fuel gas unit for introducing a first fuel gas comprising a first fuel gas conduit and a first fuel gas nozzle, wherein the first fuel gas conduit comprises a first fuel gas inlet and a first fuel gas outlet, wherein the first fuel gas inlet is in fluid connection with a first fuel gas source and the first fuel gas outlet is connected to the first fuel gas nozzle;

b. a second fuel gas unit for introducing a second fuel gas comprising a second fuel gas conduit and a second fuel gas nozzle, wherein the second fuel gas conduit comprises a second fuel gas inlet and a second fuel gas outlet, wherein the second fuel gas inlet is in fluid connection with a second fuel gas source, wherein the fuel gas from the second fuel gas source comprises at least carbon monoxide (CO) and the second fuel gas outlet is connected to the second fuel gas nozzle;

c. an auxiliary media unit comprising an auxiliary media conduit and a burner plenum, wherein the auxiliary media conduit comprises an auxiliary media inlet and an auxiliary media outlet, wherein the auxiliary media inlet is in fluid connection with an auxiliary media source and the auxiliary media outlet is connected to the burner plenum;

d. a burner tile, wherein the burner tile adjoins the burner plenum and the burner tile has a refractory surface, wherein the refractory surface adjoins a combustion zone of the process burner, wherein the burner tile and the combustion zone are configured for combustion of the first fuel gas and the second fuel gas with the auxiliary medium.

According to the invention it is provided that the first fuel gas nozzle for introducing the first fuel gas is arranged inside the combustion zone and the second fuel gas nozzle for introducing the second fuel gas is arranged inside the auxiliary media unit.

In process burners known from the prior art the fuel gas nozzles are inside the combustion zone in the region of the burner tile which forms a portion of the tip or the neck of the process burner. In the process burner according to the invention the second fuel gas nozzle is arranged inside the auxiliary media unit. The second fuel gas nozzle introduces or injects the second fuel gas which contains or consists of carbon monoxide into the process burner. According to the invention this is not effected inside the combustion zone in the region of the hot burner tip/the hot burner neck but rather inside the auxiliary media unit in a substantially cooler region of the process burner due to the arrangement of the second fuel gas nozzle. The fuel gas of the first fuel gas unit is mixed with the even cooler fuel gas of the second fuel gas unit and combusted only in the region of the combustion zone. On the way to the combustion zone the second fuel gas which contains or consists of carbon monoxide thus comes into contact with the first fuel gas only very late, if at all. On the way to the combustion zone the second fuel gas only comes into contact with the auxiliary medium, wherein due to the cooler temperatures inside the auxiliary media conduit no combustion of the second fuel gas yet takes place. It has now been found that, surprisingly, the arrangement of the second fuel gas nozzle inside the auxiliary media unit has the result that fewer solid carbon deposits are formed in the region of the fuel gas nozzles or upstream thereof, for example in the region of the fuel gas conduits.

The first fuel gas unit comprises at least one first fuel gas conduit. The first fuel gas conduit is configured as a riser conduit and provides the first fuel gas from the first fuel gas source which is introduced into the process burner via the first fuel gas nozzle in the region of the auxiliary media unit but not in the region of the burner tile or the combustion zone. The first fuel gas conduit has an inlet and an outlet. The inlet of the first fuel gas conduit is connected to the first fuel gas source. The first fuel gas from the first fuel gas source comprises little, if any, carbon monoxide. For example, the first fuel gas from the first fuel gas source comprises less than 10 mol % of carbon monoxide or less than 5 mol % or less than 2 mol % or less than t mol % or less than 0.5 mol %. It is particularly preferable when the fuel gas from the first fuel gas source is free from carbon monoxide. In one example the first fuel gas from the first fuel gas source comprises natural gas, hydrogen and/or an offgas from a pressure swing adsorption apparatus. The first fuel gas conduit may comprise a so-called fuel gas lance which opens into the first fuel gas nozzle. In this case the fuel gas lance comprises the outlet of the first fuel gas conduit.

The second fuel gas unit comprises at least one second fuel gas conduit. The second fuel gas conduit is configured as a riser conduit and provides the second fuel gas from the second fuel gas source which is introduced into the process burner via the second fuel gas nozzle in the region of the combustion zone. The second fuel gas conduit has an inlet and an outlet. The inlet of the second fuel gas conduit is connected to the second fuel gas source. The second fuel gas from the second fuel gas source comprises at least carbon monoxide (CO) which is combusted to afford carbon dioxide (CO₂) in the combustion zone of the process burner by means of the auxiliary medium. The second fuel gas is preferably rich in carbon monoxide or comprises carbon monoxide as the main component. For example, the second fuel gas comprises at least 50 mol % of carbon monoxide or at least 75 mol % of carbon monoxide or at least 90 mol % of carbon monoxide or at least 95 mol % of carbon monoxide or at least 99 mol % of carbon monoxide. In one example the second fuel gas consists of carbon monoxide, optionally in addition to a small proportion of unavoidable impurities.

The auxiliary media unit comprises at least one auxiliary media conduit and the burner plenum also known as the windbox. The auxiliary media conduit has an inlet and an outlet. The inlet of the auxiliary media conduit is connected to an auxiliary media source. The auxiliary medium is generally a gas or gas mixture which assists combustion of fuel gases. Carbon-containing fuel gases are ideally completely combusted to afford carbon dioxide by means of the auxiliary medium. Hydrogen fuel gas is ideally completely combusted to afford water by means of the auxiliary medium, wherein the water is present as steam in the combustion zone of the process burner. The auxiliary media source provides the auxiliary medium which is transported via the auxiliary media conduit, a riser conduit, to the burner plenum. A control apparatus for controlling the volume flow of the auxiliary medium may be arranged inside the auxiliary media unit, in particular inside the auxiliary media conduit. In one example such a control apparatus comprises a multiplicity of movable air slots and/or one or more air control flaps.

The burner plenum connected to the auxiliary media outlet transports the auxiliary medium to the burner tip in whose region the burner tile and the combustion zone are arranged and dampens the noise from the surrounding firing space. The burner plenum is arranged in the vicinity of the burner tile, adjoining it directly or indirectly via further components. The auxiliary media conduit may further comprise a further (sound) absorber adjoining the burner plenum.

The burner tile has a refractory surface. In one example the refractory surface consists of a ceramic. The refractory surface of the burner tile directly adjoins the combustion zone of the process burner which operates at temperatures of up to 2000° C. The combustion zone is at least partially formed by the flame of the process burner.

An ignition burner or pilot burner for starting the combustion reaction is typically arranged in the region of the burner tip, often also referred to as the burner neck or burner quail.

A preferred embodiment of the process burner according to the invention is characterized in that the second burner gas nozzle for introducing the second burner gas is arranged inside the burner plenum.

A preferred embodiment of the process burner according to the invention is characterized in that the second fuel gas conduit at least partially extends through the burner plenum.

The objects of the present invention are further at least partially achieved by a steam reformer or steam cracker which comprises a process burner according to the invention.

The objects of the present invention are further at least partially achieved by a process for combustion of a plurality of fuel gases with a gaseous auxiliary medium in a process burner, wherein the process burner contains a first fuel gas unit, a second fuel gas unit and an auxiliary media unit and wherein one of the fuel gases comprises carbon monoxide (CO), comprising the following process steps which need not necessarily be performed in the intended sequence:

a. introducing a first fuel gas from a first fuel gas source into a first fuel gas unit, wherein the first fuel gas unit comprises a first fuel gas conduit and a first fuel gas nozzle;

b. introducing a second fuel gas from a second fuel gas source into a second fuel gas unit, wherein the fuel gas from the second fuel gas source comprises at least carbon monoxide (CO) and wherein the second fuel gas unit comprises a second fuel gas conduit and a second fuel gas nozzle;

c. introducing an auxiliary medium from an auxiliary media source into an auxiliary media unit, wherein the auxiliary media unit comprises an auxiliary media conduit and a burner plenum;

d. introducing the first fuel gas via the first fuel gas nozzle into a combustion zone of the process burner, wherein the combustion zone adjoins a refractory surface of a burner tile and the burner tile adjoins the burner plenum;

e. introducing the second fuel gas into the auxiliary media unit via the second fuel gas nozzle;

f. combusting the first fuel gas and the second fuel gas with the auxiliary medium in the combustion zone of the process burner.

In contrast to known processes the second fuel gas is not introduced into the combustion zone of the process burner but rather into the auxiliary media unit of the process burner via the second fuel gas nozzle. As is known from process burners of the prior art the first fuel gas is introduced into the combustion zone of the process burner via the first fuel gas nozzle. Only in the combustion zone is the second fuel gas which comprises carbon monoxide (CO) brought into contact and mixed with the first fuel gas and corn busted using the auxiliary medium. On the way into the combustion zone the second fuel gas comes into contact exclusively or almost exclusively with the auxiliary medium. It has now been found that this type of process management has the result that fewer solid carbon deposits are formed in the region of the fuel gas nozzles or upstream thereof, for example in the region of the fuel gas conduits.

A preferred embodiment of the process according to the invention is characterized in that the second fuel gas is introduced into the burner plenum of the auxiliary media unit.

A preferred embodiment of the process according to the invention is characterized in that the fuel gas from the second fuel gas source comprises at least 50 mol % of carbon monoxide, preferably at least 90 mol % of carbon monoxide and more preferably at least 95 mol % of carbon monoxide.

A preferred embodiment of the process according to the invention is characterized in that the auxiliary media source comprises air, oxygen or oxygen-enriched air.

A preferred embodiment of the process according to the invention is characterized in that the second fuel gas is introduced via the second fuel gas nozzle at a temperature of less than 160° C., preferably at a temperature of less than 140° C., especially preferably at a temperature of less than 135° C. and more preferably at a temperature of less than 100° C.

The activation energy of the carbon formation reaction from carbon monoxide according to the Boudouard equilibrium is typically between 150 kJ/mol and 400 kJ/mol depending on whether the activation energy is reduced by a catalyst or not. For the uncatalyzed reaction which must be assumed for introduction of carbon monoxide into a process burner the maximum allowable temperatures were determined in computer simulations using the program Aspen+. The maximum allowable temperatures should not be exceeded in the region of the second fuel gas nozzle to inhibit the formation of solid carbon from carbon monoxide. It has especially been found that a temperature of 140° C. should not be exceeded, more preferably a temperature of 135° C. should not be exceeded, wherein still lower temperatures, in particular of less than 100° C., are more preferred.

A preferred embodiment of the process according to the invention is characterized in that the ratio of the volume flow of the auxiliary medium, in particular of air, relative to the volume flow of the second fuel gas, is 15:1 to 10:1, preferably 14:1 to 12:1.

It has been found that the maximum allowable temperature in the region of the second fuel gas nozzle can be observed especially at the abovementioned ratios of the volume flow of the auxiliary medium relative to the volume flow of the second fuel gas.

A preferred embodiment of the process according to the invention is characterized in that the second fuel gas is introduced into the second fuel gas unit at a temperature of 20° C. to 50° C., preferably introduced into the second fuel gas unit at a temperature of 30° C. to 40° C.

It is further preferable when the auxiliary medium is introduced into the auxiliary media unit at a temperature of 250° C. to 350° C.

The carbon formation reaction may be avoided especially when the auxiliary medium is preheated to a highest possible temperature and the second fuel gas is introduced into the auxiliary media unit via the second fuel gas nozzle at a lowest possible temperature while at the same time the abovementioned maximum allowable temperatures should not be exceeded.

The objects of the present invention are further at least partially achieved by a use of the process burner according to the invention in a process according to the invention.

The objects of the present invention are further at least partially achieved by a use of the process burner according to the invention in a steam reformer or steam cracker.

### BRIEF DESCRIPTION OF THE DRAWINGS

The invention is hereinbelow more particularly elucidated by an exemplary embodiment and numerical examples. In the following detailed description reference is made to the accompanying FIGURE which forms a part of the exemplary embodiment and which contains an illustrative representation of a specific embodiment of the invention. In this connection, direction-specific terminology such as “top”, “bottom”, “front”, “back”, etc., is used with reference to the orientation of the described FIGURE. Since components of embodiments may be positioned in a multiplicity of orientations, the direction-specific terminology is used for elucidation and is in no way limiting. A person skilled in the art will appreciate that other embodiments may be used and structural or logical changes may be undertaken without departing from the scope of protection of the invention. The following detailed description is therefore not to be understood in a limiting sense, and the scope of protection of the embodiments is defined by the accompanying claims. Unless otherwise stated the drawing is not to scale,

FIG. 1 shows an inventive process burner 100 having a first fuel gas unit, a second fuel gas unit and an auxiliary media unit.

### DETAILED DESCRIPTION OF PREFERRED EMBODIMENTS

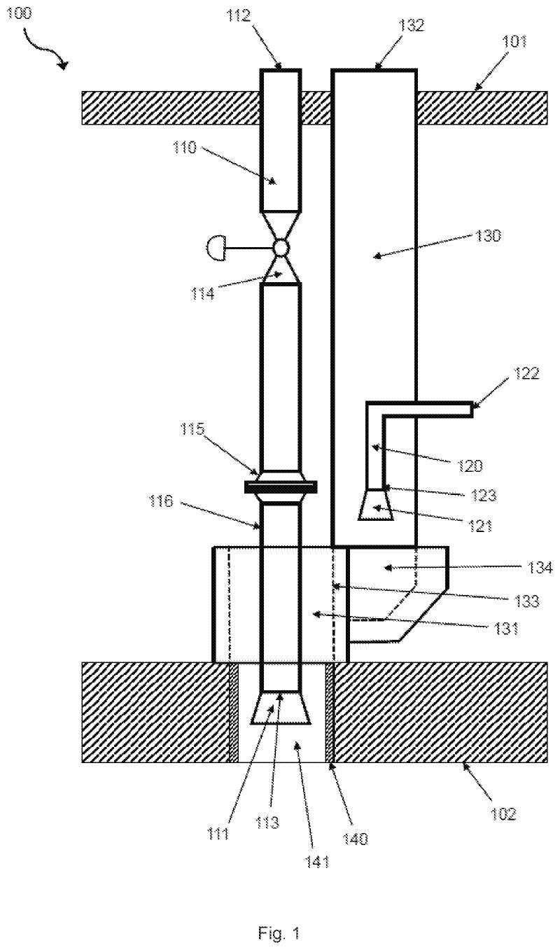

Process burner 100 according to FIG. 1 is configured for operation in a steam reformer and is operated with natural gas as the first fuel gas and pure carbon monoxide (purity >99% by weight) as the second fuel gas. Ambient air is used as the auxiliary medium.

The process burner 100 is secured via a steel construction 101 located outside the combustion space of the steam reformer. The flame of the process burner 100 radiates downwards into the radiation space of the steam reformer which is externally delimited by a refractory wall 102. Arranged in the radiation space of the steam reformer are a plurality of nickel catalyst-filled reaction tubes which are heated by a multiplicity of the depicted process burners 100. Inside the reaction tubes natural gas is reacted with steam to afford synthesis gas in an endothermic reaction.

The process burner 100 comprises a first fuel gas unit which comprises at least one first fuel gas conduit 110, a first fuel gas nozzle 111, a flow controller 114, a flange 115 and a lance 116. The first fuel gas conduit 110 comprises a first fuel gas inlet 112 and a first fuel gas outlet 113. The first fuel gas inlet 112 is in fluid connection with a first fuel gas source (not shown). The first fuel gas source is natural gas. The amount of flow of the first fuel gas (natural gas), i.e. the volume flow of the first fuel gas, is varied via the flow controller 114. A portion of the first fuel gas conduit 110 is the burner lance 116 which is connected via a flange 115 to the upper section of the fuel gas conduit 110. The burner lance 116 which thus forms a portion of the first fuel gas conduit 110 partially extends through a burner plenum 131 and opens into the first fuel gas nozzle 111 through which the first fuel gas is introduced into the process burner 100, more particularly into a combustion space 141 of the process burner 100.

The process burner 100 further comprises a second fuel gas unit which comprises at least one second fuel gas conduit 120 and a second fuel gas nozzle 121. The second fuel gas conduit 120 may likewise comprise a flow controller for the second fuel gas (not shown). The second fuel gas conduit 120 comprises a second fuel gas inlet 122 and a second fuel gas outlet 123. The second fuel gas inlet 122 is in fluid connection with a second fuel gas source (not shown). The second fuel gas source is pure carbon monoxide (purity at least 99% by weight). The second fuel gas nozzle 121 is connected to the second fuel gas conduit via the second fuel gas outlet 123. The second fuel gas nozzle is arranged inside an auxiliary media unit, more particularly inside an auxiliary media conduit 130. The portion of the second fuel gas conduit 120 opening into the second fuel gas nozzle 121 may likewise be configured as a burner lance.

The process burner 100 further comprises an auxiliary media unit which comprises at least one auxiliary media conduit 130, a sound absorber 134 and a burner plenum 131 (windbox). The auxiliary media conduit 130 comprises an auxiliary media inlet 132 and an auxiliary media outlet 133, The auxiliary media inlet 132 is in fluid connection with an auxiliary media source (not shown). The auxiliary medium from the auxiliary media source is ambient air. The auxiliary media outlet 133 is connected to the burner plenum 131 or is at least in fluid connection with the burner plenum 131, The burner plenum 131 conducts and distributes the auxiliary medium (air) in the direction of the burner tip or the burner neck (lower portion of the process burner), A portion of the auxiliary media conduit 130 is the sound absorber 134 which here comprises the auxiliary media outlet 133 and opens into the burner plenum 131. The sound absorber 134 absorbs the sound from the adjoining reformer furnace.

Adjoining the burner plenum 131 is the burner tile 140 which is here configured as a hollow-cylindrical burner tile 140 and has a refractory surface (not shown) at least on its inside. In other embodiments the burner plenum 131 may be merely in fluid connection with the burner tile 140, without there being a direct connection between the burner plenum 131 and the burner tile 140. Adjacent to the refractory surface of the burner tile 140 is the combustion space 141 of the process burner 100 in which the actual combustion of the first and second fuel gas with the auxiliary medium (air) is carried out. A portion of the first fuel gas conduit 110, here the burner lance 116, and the first fuel gas nozzle 111 extend into the combustion space. Produced in the combustion space 141 is a flame which radiates downwards into the radiation space of the steam reformer.

The inventive process burner 100 may comprise a plurality of first and/or second fuel gas units. In one example a first fuel gas unit may be arranged centrally and surrounded by a plurality of further first fuel gas units. The inventive process burner 100 may thus be configured as a fuel staged or air staged process burner. In these configurations known to those skilled in the art the combustion reaction is retarded, thus reducing undesired NOx emissions. The inventive process burner moreover comprises a pilot or start-up burner in the region of the burner tile 140 to initiate the combustion reaction inside the combustion zone 141.

In alternative embodiments the second fuel gas nozzle 121 may also be arranged inside the sound absorber 134 or the burner plenum 131 which both form a portion of the auxiliary media unit. In the combustion zone 141 temperatures of about 1500° C. to 2000° C. may prevail. By contrast, the temperatures inside the auxiliary media unit are several times lower. In particular the inventive process burner 100 may be configured such that the temperatures at the outlet of the second fuel gas nozzle 121 are below 200° C. or even below 100° C. This effectively prevents the undesired Boudouard reaction of two mol of carbon monoxide to afford one mole of solid carbon (graphite) and carbon dioxide from occurring at the outlet of the second fuel gas nozzle 121 since the activation energy for this reaction is not achieved. The second fuel gas unit is thus not affected by blockages through carbon deposits. While the temperature of the second fuel gas does subsequently continue to increase in the direction of the burner plenum 131 and the second fuel gas does ultimately also “see” high temperatures in the combustion zone 141 dilution with the first fuel gas takes place here and it is also virtually impossible for carbon formed in the combustion zone 141 to be deposited on the inside of the first fuel gas nozzle 111. This is because there prevails in the first fuel gas nozzle 111 a certain pressure drop in the direction of the combustion space which ensures that carbon particles do not pass into the interior of the second fuel gas nozzle 121 but rather are conducted away in the direction of the radiation space of the reformer furnace with the flue gas.

The following table reports four inventive Examples 1 to 4 whose data were determined by computer simulations using the software Aspen+.

| | | Example | Example | Example | Example |
|---|---|---|---|---|---|
| | | 1 | 2 | 3 | 4 |
| CO flow rate | Nm³/h | 151 | 30 | 151 | 30 |
| Interior diameter | mm | 20.9 | 20.9 | 15.8 | 15.8 |
| (CO outlet | | | | | |
| second fuel gas | | | | | |
| T (air)conduit) | ° C. | 310 | 310 | 310 | 310 |
| T (CO) | ° C. | 35 | 35 | 35 | 35 |
| T (second fuel | ° C. | 99 | 178 | 86 | 159 |
| gas conduit | | | | | |
| outlet, outside) | | | | | |
| T (second fuel | ° C. | 99 | 176 | 84 | 157 |
| gas conduit | | | | | |
| outlet, inside) | | | | | |

Pure carbon monoxide was used as the second fuel gas and this was introduced into the process burner via the second fuel gas nozzle in the region of the auxiliary media unit at a temperature of 35° C. and a pressure of 3 bang. The auxiliary medium, in this case preheated air, passes through the auxiliary media conduit at a temperature of 310° C. The flow rate of the carbon monoxide introduced into the process burner via the second fuel gas conduit in the region of the auxiliary media unit, and the diameter at the outlet for carbon monoxide at the second fuel gas conduit (second fuel gas outlet) which opens into the second fuel gas nozzle, were varied.

Arranging the second fuel gas nozzle in the region of the auxiliary media unit has the result that temperatures of markedly below 200° C., advantageously below 100° C., are to be expected in the region of the second fuel gas nozzle when the flow rate of carbon monoxide is appropriately high (Examples 1 and 3). The low temperatures at the outlet of the second fuel gas conduit effectively inhibit formation of carbon from carbon monoxide in this region, especially at high CO flow rates. At the high flow rates of the Examples 1 and 3 it can be assumed that the formation of solid carbon from CO is particularly effectively inhibited since at temperatures of below 135° C. it can be assumed that the activation energy of the Boudouard reaction of two mol of carbon monoxide to afford one mole of solid carbon (graphite) and carbon dioxide (uncatalyzed case) is not achieved at least in the region of the outlet of the second fuel gas conduit.

The following table shows two further inventive Examples 5 and 6. The temperature for the auxiliary medium (air) was somewhat lower here and the volume flow of the auxiliary medium was adjusted so as to result in a ratio of volume flows of auxiliary medium to carbon monoxide (second fuel gas) of about 13:1. In both examples a temperature of markedly below 135° C. was in turn determined in the region of the outlet of the second fuel gas conduit and it can therefore be assumed that the activation energy for the carbon formation reaction is not achieved at least in the region of the outlet of the second fuel gas conduit.

| | | Example 5 | Example 6 |
|---|---|---|---|
| CO flow rate | Nm³/h | 54.8 | 42.8 |
| Air flow rate | Nm³/h | 706.4 | 551.0 |
| Interior | mm | 20.9 | 20.9 |
| diameter | | | |
| (CO outlet) | | | |
| T (air) | ° C. | 270 | 270 |
| T (CO) | ° C. | 35 | 35 |
| T (fuel gas | ° C. | 117 | 121 |
| conduit | | | |
| outlet, | | | |
| outside) | | | |
| T (fuel gas | ° C. | 115 | 119 |
| conduit | | | |
| outlet, inside) | | | |

### LIST OF REFERENCE NUMERALS

100 Process burner
101 Steel construction
102 Reformer furnace wall
110 First fuel gas conduit
111 First fuel gas nozzle
112 First fuel gas inlet
113 First fuel gas outlet
114 Row controller
115 Range
116 Burner lance
120 Second fuel gas conduit
121 Second fuel gas nozzle
122 Second fuel gas inlet
123 Second fuel gas outlet
130 Auxiliary media conduit
131 Burner plenum
132 Auxiliary media inlet
133 Auxiliary media outlet
134 Sound absorber
140 Burner the
141 Combustion zone

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A process burner for combustion of a plurality of fuel gases with a gaseous auxiliary medium, wherein one of the fuel gases comprises carbon monoxide (CO), comprising:
a. a first fuel gas unit configured to introduce a first fuel gas, comprising a first fuel gas conduit and a first fuel gas nozzle, wherein the first fuel gas conduit comprises a first fuel gas inlet and a first fuel gas outlet, wherein the first fuel gas inlet is in fluid connection with a first fuel gas source and the first fuel gas outlet is connected to the first fuel gas nozzle;
b. a second fuel gas unit for introducing a second fuel gas, comprising a second fuel gas conduit and a second fuel gas nozzle, wherein the second fuel gas conduit comprises a second fuel gas inlet and a second fuel gas outlet, wherein the second fuel gas inlet is in fluid connection with a second fuel gas source, wherein the fuel gas from the second fuel gas source comprises at least carbon monoxide and the second fuel gas outlet is connected to the second fuel gas nozzle;
c. an auxiliary media unit comprising an auxiliary media conduit and a burner plenum, wherein the auxiliary media conduit comprises an auxiliary media inlet and an auxiliary media outlet, wherein the auxiliary media inlet is in fluid connection with an auxiliary media source and the auxiliary media outlet is connected to the burner plenum;
d. a burner tile, wherein the burner tile adjoins the burner plenum and the burner tile has a refractory surface, wherein the refractory surface adjoins a combustion zone of the process burner, wherein the burner tile and the combustion zone are configured for combustion of the first fuel gas and the second fuel gas with the auxiliary medium,
wherein,
the first fuel gas nozzle for introducing the first fuel gas is arranged inside the combustion zone and
the second fuel gas nozzle for introducing the second fuel gas is arranged inside the auxiliary media unit.

2. The process burner according to claim 1, wherein the second burner gas nozzle for introducing the second burner gas is arranged inside the burner plenum.

3. The process burner according to claim 1, wherein the second fuel gas conduit at least partially extends through the burner plenum.

4. A steam reformer or a steam cracker, comprising a process burner according to claim 1.

5. A process for combustion of a plurality of fuel gases with a gaseous auxiliary medium in a process burner, wherein the process burner comprises a first fuel gas unit, a second fuel gas unit and an auxiliary media unit and wherein one of the fuel gases comprises carbon monoxide, comprising the following process steps:
a. introducing a first fuel gas from a first fuel gas source into the first fuel gas unit, wherein the first fuel gas unit comprises a first fuel gas conduit and a first fuel gas nozzle;
b. introducing a second fuel gas from a second fuel gas source into the second fuel gas unit, wherein the fuel gas from the second fuel gas source comprises at least carbon monoxide and wherein the second fuel gas unit comprises a second fuel gas conduit and a second fuel gas nozzle;
c. introducing an auxiliary medium from an auxiliary media source into the auxiliary media unit, wherein the auxiliary media unit comprises an auxiliary media conduit and a burner plenum;
d. introducing the first fuel gas via the first fuel gas nozzle into a combustion zone of the process burner, wherein the combustion zone adjoins a refractory surface of a burner tile and the burner tile adjoins the burner plenum;
e. introducing the second fuel gas into the auxiliary media unit via the second fuel gas nozzle;
f. combusting the first fuel gas and the second fuel gas with the auxiliary medium in the combustion zone of the process burner.

6. The process according to claim 5, wherein the second fuel gas is introduced into the burner plenum of the auxiliary media unit.

7. The process according to claim 5, wherein the fuel gas from the second fuel gas source comprises at least 50 mol % of carbon monoxide.

8. The process according to claim 5, wherein the auxiliary media source comprises air, oxygen or oxygen-enriched air.

9. The process according to claim 5, wherein the second fuel gas is introduced via the second fuel gas nozzle at a temperature of less than 160° C.

10. The process according to claim 5, wherein the ratio of the volume flow of the auxiliary medium relative to the volume flow of the second fuel gas, is 15:1 to 10:1.

11. The process according to claim 5, wherein the second fuel gas is introduced into the second fuel gas unit at a temperature of 20° C. to 50° C.

12. The process according to claim 5, wherein the auxiliary medium is introduced into the auxiliary media unit at a temperature of 250° C. to 350° C.
